(19) United States
(12) Patent Application Publication
(10) Pub. No.: US 2004/0059589 A1
(43) Pub. Date: Mar. 25, 2004

(54) Method of managing risk

(76) Inventors: Richard N. Moore, Dunlap, IL (US); Stacy E. Smith, Washington, IL (US); Phillip A. Weingart, Metamora, IL (US); Martha J. Zimmerman, Avon, IL (US)

Correspondence Address: CATERPILLAR INC., 100 N.E. ADAMS STREET, PATENT DEPT., PEORIA, IL, 616296490

(21) Appl. No.: 10/264,978

(22) Filed: Oct. 4, 2002

Related U.S. Application Data
(60) Provisional application No. 60/412,013, filed on Sep. 19, 2002.

(51) Int. Cl. G06F 17/60

(52) U.S. Cl. 705/1; 705/7

(57) ABSTRACT

The present disclosure is associated with a method of managing risk associated with a process. The method includes the steps of, establishing a scoped risk management process in response to the established process, identifying at least one risk associated with the process in response to the scoped risk management process, and assessing an impact of the at least one identified risk on the process.

This application claims the benefit of prior provisional patent application serial No. 60/412,013 filed Sep. 19, 2002

### TECHNICAL FIELD

The present invention relates generally to a method of managing risk, and more particularly to a method of managing risk associated with a process.

### BACKGROUND

Risk management is becoming an increasingly useful corporate tool. Companies are attempting to proactively acquire a better understanding of the risks that may impact corporate objectives. In general, risk management is a proactive process to identify, assess, and manage business risk associated with a process. Prior risk management processes may take an extensive amount of time to perform. For example, the identification and assessment of the risk may take up to several months for the review of a selected process. Several months is a major time commitment in many business environments. It is difficult for managers to commit the resources to review their process in light of the time it will take. In addition, prior risk management processes had deliverables that were due produced after the risk identification and assessment processes were over, thereby further extending the time period, resources, and cost involved in the process review.

The present invention is directed to overcoming one or more of the problems set forth above.

### SUMMARY OF THE INVENTION

In one aspect of the present invention, a method of managing risk associated with a process is disclosed. The method includes the steps of establishing a scoped risk management process in response to the process, identifying at least one risk associated with the process in response to the scoped risk management process, assessing an impact of the at least one identified risk on the process.

In another aspect of the present invention, a method of managing risk associated with a process is disclosed. The method includes the steps of identifying at least one risk associated with the process, establishing an inherent risk value associated with the identified risk, establishing a residual risk value associated with the identified risk, and assessing the process in response to the inherent risk value and the residual risk value.

In another aspect of the present invention, a method of managing risk associated with a process is disclosed. The method includes the steps of identifying at least one risk associated with the process, establishing a maturity value associated with at least one of the process and a risk mitigation process; and, assessing said process in response to the maturity value and the identified risk.

In another aspect of the present invention, a method of managing risk associated with a process is disclosed. The process is associated with a multi-tiered organization. The method includes the steps of, establishing the process to be managed at a lower-tier of said multi-tiered organization, identifying at least one risk associated with the process, the identification occurring at the lower-tier, assessing an impact of the risk, the assessment occurring at the lower-tier, and delivering a direct assurance to an upper tier of the multi-tiered organization.

### BRIEF DESCRIPTION OF THE DRAWINGS

FIG. 1 is an illustration of one embodiment of a method of managing risk associated with a process;

FIG. 2 is an illustration of a risk map associated with a process;

FIG. 3A is an illustration of a scale associated with a risk radar;

FIG. 3B is an illustration of a risk radar associated with a process;

FIG. 4 is an illustration of a risk matrix;

FIG. 5 is an illustration of a risk map; and

FIG. 6 is an illustration of a risk radar.

### DETAILED DESCRIPTION

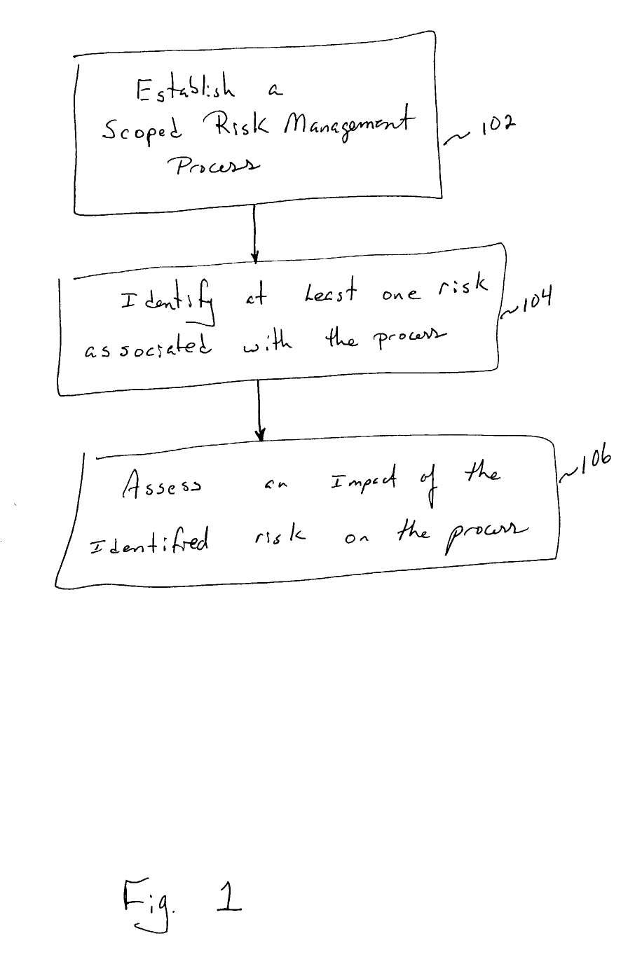

The present disclosure is associated with a method of managing risk associated with a process. Risk may be described as anything that may impact the achievement of an organization's objectives. Risk reflects an unknown variability. An organization may be described as a business, entity, company, or any portion thereof, e.g., a department within a business, or a project within a department. The process being managed may be a process, project, business objective, or any type of business function. In one embodiment, the method of managing the risk associated with the process includes the steps of establishing a scoped risk management process associated with the process under review, identifying at least one risk associated with the process under review, and assessing an impact of the risk on the process, as illustrated in FIG. 1. A company may have a risk management team, or coordinator, (e.g., internal or external consultants) that interacts with organizations (e.g., departments) within the company to implement risk management. In one embodiment, risk management may include performing one or more self-assessments. A self-assessment, as will be described, is a process where the organization performs a risk review to identify and assess the risk associated with a process. Risk reviews performed with the aid of the risk management team or coordinator may be referred to as facilitated self-assessments. The coordinator could be a person internal to the organization performing the self-assessment.

When an organization decides to perform a self-assessment, a scoped risk management process is established. In general, establishing a scoped risk management process involves spending a small amount of time prior to an engagement period, in order to focus the risk identification and assessment processes performed during the engagement period. The engagement period may be described as the period of time a risk management team or coordinator spends with an organization to facilitate a risk self-assessment. If the self-assessment is not facilitated, the engagement period may still refer to the time period during which the analogous self-assessment activities are performed. The scoped process may result in a reduced time period and/or reduced resources needed during the engagement period, thereby saving time, resources and money. As discussed below, establishing a scoped risk management process may include at least one or more of: identifying an engagement sponsor or process owner, coordinating with the engagement sponsor, identifying the objectives and scope of the upcoming risk management engagement, establishing what process to review, correlating the process to be reviewed with the organization's other processes, establishing a risk time period, establishing what risk types may impact the process, and scoping an upcoming interview process based upon the risk time period, correlated processes, potential risk types, customer expectations, and/or other information obtained from a scoping meeting.

In one embodiment, establishing a scoped management process includes identifying an engagement sponsor (i.e., one or more people responsible for having the engagement performed) or a process owner (i.e., one or more people accountable for the performance of the process or fulfillment of an objective). The engagement sponsor may also have the authority to control the operation(s) associated with the process. The following discussion will refer to the involvement of the engagement sponsor. However, the process owner could be used in addition or instead of the engagement sponsor. The risk management team/coordinator then coordinates with the engagement sponsor, e.g., through a meeting. The purpose of the meeting is to identify the objectives and scope of the risk management engagement, including the engagement period. The meeting may be referred to as a scoping meeting.

The meeting may include determining what process to review, if it hasn't been decided already. The selected process may be a high level process, a subset of a process, or a project associated with a business objective or critical success factor. A critical success factor is a factor identified by the organization this is important in achieving success. The selected process may then be correlated with the organization's other processes, e.g., such as key processes or key business activities. Key business activities are major business processes and activities that the organization undertakes to ensure achievement of the organization's objectives. Examples of key business activities include: social responsibility, corporate governance, strategic business planning, product and/or service development, sales capability/customer relationship management, order fulfillment, product and service support, information management, financial products, accounting and reporting, human resources, and treasury. The key business activities of the organization may have been previously established. For example, the key business activities of a company may be established by top managers of the company and passed downward to other departments within the company. Alternatively the key business activities may be established by the department performing the review, independent of what other departments are doing. Correlating the key business activities with the process may include identifying which of the key business activities are impacted by the process under review. For example, inventory management may impact order fulfillment, while having little or no impact on treasury.

A risk time period is established during the scoping meeting. A risk time period is a time period in which the risks associated with the process are to be considered. For example, if the risk time period is twelve months, then, when the risk are being identified that may impact the process, the risk to be considered are those that may occur (or impact the process) within the next twelve months. Establishing the risk time period may be based on factors such as project deadlines (e.g., implementing a new purchasing system in twelve months), the capability maturity of the process being reviewed (the less mature the process, the less the risk time period extends into the future), upcoming events associated with the process, recent or upcoming reorganizations, or changes in strategy etc. In general the customer may guide the establishment of the risk time period based on their knowledge of their business, and upcoming issues/events that are associated with their business. In the context of a facilitated self-assessment the term “customer” may be used to refer to the organization performing the risk review.

The scoping meeting may include a discussion of the risks that may affect the process, and thereby affect the associated key business activity. In one embodiment, the organization may have established risk types. Risk types may be baseline types of risks that may impact the company and/or the organization. Generally, only a subset of the risk types will be applicable to any particular process. The applicable risk types are determined on a process by process basis. In one embodiment, the baseline risk types may be determined by an upper tier of the company, and passed downwards. Therefore, an initial discussion of potential risk types may be performed to narrow the applicable risk types, thereby further focusing later activities during the identification and assessment process. In one embodiment, if the baseline list of risks is not comprehensive, risks other than the baseline risk types may be identified as potentially applicable to the process.

The step of establishing a scoped risk management process also includes establishing the objectives of the engagement period with the engagement sponsor. For example, the deliverables of the engagement process may be identified. In addition, the time period (or engagement period) of the engagement process may be identified. In one embodiment, the engagement period and deliverables are established such that all of the deliverables are completed prior to concluding the engagement period. If a desired deliverable is established that would take longer to complete than the engagement period, then the deliverable is considered out of scope of the engagement process and is not pursued. Examples of deliverables include an executive summary (or short summary of the engagement activities), the key themes (a summary of key themes gathered during the interviews of the management team), a risk map (including the significance and likelihood of the top risks identified for the process under review), a risk radar (including identification of the key business activities, associated risk, and the status of the assessment), and an action plan (including a framework to begin plans that mitigate or leverage the most significant risks and opportunities to the process under review and ensure appropriate controls are functioning effectively).

Additional information that may be obtained during the scoping meeting with the engagement sponsor(s) includes:

Recent organizational changes that may affect the process being reviewed. (Organizational changes reflect increased risk due to new management style or processes)

Trends the organization is facing that should be considered. (Identifying trends may help to identify upcoming risks that are not currently being encountered)

The organizational strategy and any recent revisions. (This also may reflect increased risk due to a new, possibly untested, strategy)

The specific information that may be reviewed by the risk management team prior to the engagement period. (This helps to prepare the team by pinpointing relevant material to be reviewed in advance)

A list of participants, and their roles in the engagement process. (This helps narrow the interview candidates from everyone in the organization to the appropriate people, thereby reducing time and resource utilization).

After the meeting with the engagement sponsor(s), as part of the scoping process, the risk management team or coordinator may focus the activities for the upcoming engagement period. For example, an interview process is utilized during the engagement period. The interview process includes meeting with selected people of the organization to identify and discuss potential risk associated with the process, among other issues. The upcoming interview process may be focused during the scoping process. The interview process to be used during the engagement period may be scoped (or tailored) to the process being reviewed based upon the risk time period, the subset of business activities, potential risk types, customer expectations, and/or other information obtained during the scoping meeting. For example, an interview process may utilize baseline (or default) questions. The baseline questions may be tailored to the particular process being reviewed. Questions may be eliminated, or modified, because they don't apply to the subset of business activities, or they don't apply to the risk time period. Therefore the interview process is tailored to the particular process being reviewed during the scoping process.

The engagement period may then be conducted based on the established scoped risk management process. In general, the engagement period includes the steps of identifying at least one risk associated with the process under review, and assessing an impact of the identified risk on the process under review. The risk identification and risk assessment steps are performed utilizing the results of the scoped risk management process. In one embodiment, the risk identification step begins with a kick off meeting with the risk management team and the identified organization participants. The purpose of the kick off meeting is to present the established objectives/expectations of the engagement period, explain the risk identification and assessment process, discuss the process being reviewed, review the initial set of applicable business activities and the associated risk time period, and receive comments on any of these issues. In one embodiment, the engagement period expectations, tailored interview questions and/or risk time period may be modified in response to feedback received during the kick-off meeting. In addition, the confidential nature of the engagement may be discussed. For example, the discussion may include how the results of the engagement period will be used, and also how the information gathered during the interviews etc., will be collected, disseminated, and analyzed such that the originator of the information is maintained in confidence.

After the kick off meeting, interviews are held with the identified participants of the organization and the risk management team. The interviews are conducted to identify the risks that may be associated with the processes being reviewed. For example, risks which cause variability in the key business activities associated with the process may be identified. In one embodiment, only one individual is met with at a time. In this manner an individual's opinions regarding the risk associated with the process may be more forthcoming. In addition, the interview results associated with the individual are recorded anonymously, again to encourage more forthcoming responses. In one embodiment, interview comments are correlated with risk types, during or immediately following the interview, to facilitate rapid identification of applicable risks.

While the interview format is implementation dependent, the interview may begin with an initial discussion of the process and the interviewee's role in the process. The initial discussions may be followed by detailed questions regarding the risks the individual believes to be associated with the process, why the individual believes these to be risks associated with the process, what is the significance of the risk (e.g., what impact may the risk have toward the achievement of goals), what priorities the individual believes the risk are, and other type of follow-up questions. In one embodiment, the root cause (perceived or otherwise) of the risk may be discussed. That is, issues such as why the risk exists, what causes the risk to exist, what factors contribute to changes in the risk, etc., may be discussed. In one embodiment, the interviewer may also identify any known processes that may be used to mitigate the identified risk, the effectiveness of the mitigation processes, and the maturity of the mitigation processes. If an issue isn't discussed in these interviews, e.g., prioritizing the risk etc., then it will be discussed in the upcoming group meetings to get a group consensus of the issue. Even if an issue is discussed during the interviews, it may be further addressed during the group meetings to reach group consensus. In one embodiment, the information gathered through an interview may be gathered instead through a survey. For example, if the number of participants is such that individual interviews would consume too much time, paper or electronic surveys may be completed. The interview results may be compiled upon completion of the interviews, and the assessment of the impact of the risk may begin. The interview results may be used to establish an initial assessment of the risk, such as, the importance of the identified risk, e.g., in the context of key business activity performance. The initial assessment may be based upon the individual's priority of the risk, how many individuals cited the risk, etc. If any risk mitigation processes or root causes of the risk were identified during the interview process, the collected information associated with these issues may also be compiled. The interview compilation (including the initial assessment) may be considered part of the risk identification process or the beginning of the risk assessment process.

Compiling interview results includes correlating risks that were discussed during the various interviews. The risk types discussed during the interviews may be used to establish key themes for further review during group meetings. Key themes are themes based on the most frequently commented on risks. For example, assume thirty different risks were identified during the interviews, five of these risks were each identified by 70% of the interviewees, and the remainder where only identified by a nominal number of the interviewees. The five most frequently identified risks would provide the basis for the key themes. The rationale being that for the purpose of effective time management, the time in the group sessions (discussed below) should be focused on the most frequently cited risks, i.e., the key themes. In one embodiment, a brief review of the other risks may be performed with the group to ensure that a significant risk wasn't overlooked. As previously mentioned, having categorized comments during, or immediately after, the interview process helps facilitate a rapid initial assessment of the risk.

Upon completion of the initial risk assessment, the assessment process includes bringing the participants together in a facilitated group session to discuss the initial assessment. The facilitated session provides a forum in which to discuss each of the identified risks, or key themes, the perceived root cause of the risk, and the significance and likelihood of the risk. The facilitated session may be used to gain consensus on the key risks that impact the organization's objectives (or the objectives of the process under review). The relevant risk types (or key themes) may be prioritized by the participants. In one embodiment, prioritization may occur through anonymous voting. Anonymous voting may be used to promote freer expression of risk and/or significance and likelihood of risk types, without feeling any pressure to prioritize risk in a particular order. In one embodiment, electronic voting techniques may be utilized in order to facilitate anonymous voting.

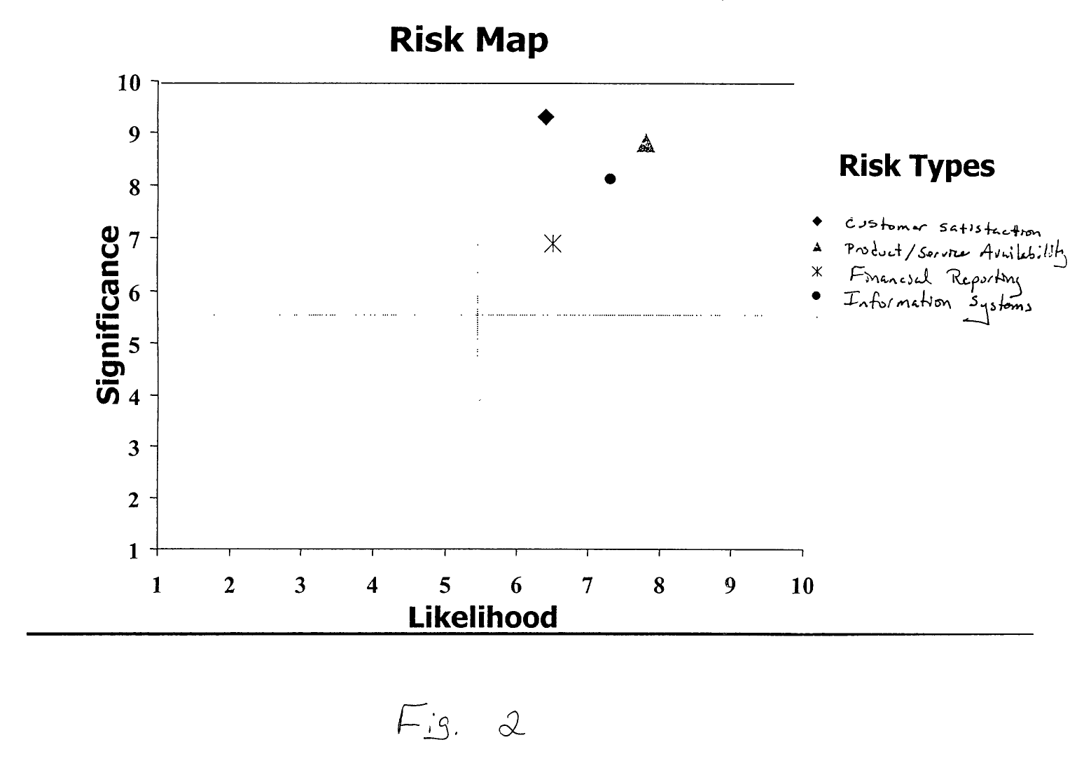

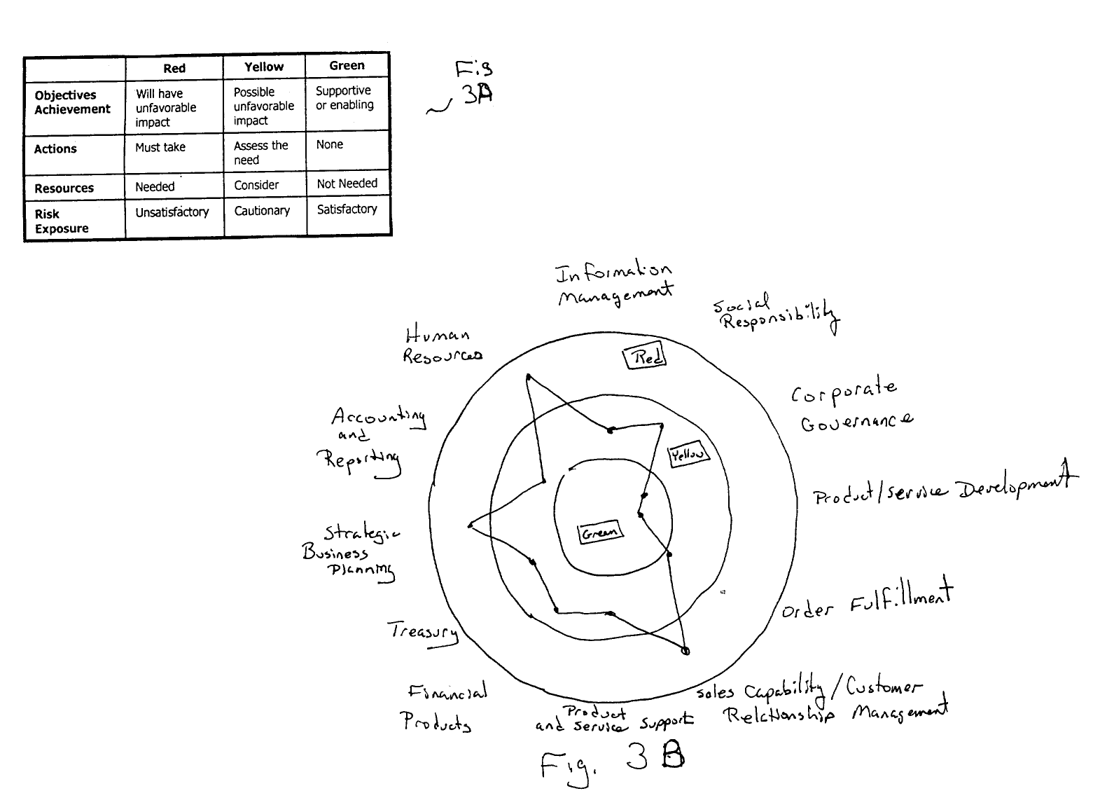

Prioritizing the risk may include creating a visual indication of the risk. In one embodiment, the visual indication may be a visual summarization of the risk such as a risk map, as illustrated in FIG. 2, and/or a risk radar, as illustrated in FIGS. 3A and 3B. However, other forms of visual indications may include bar charts, pie charts, or other forms of graphically comparing and/or compiling a plurality of factors with one another.

A risk map may be created to help depict the significance and likelihood of occurrence of a particular risk(s). The risk map depicts a visual illustration of the significance and likelihood of occurrence of a risk, as determined by the group, as shown in FIG. 2. The risk map may enable the group to prioritize the risk. The prioritized risk may facilitate the subsequent management of the risk. For example, a risk having a high significance, and a high likelihood of occurrence, may be given a high priority. A higher priority may mean that time and resources should be spent attempting to mitigate the risk.

In one embodiment, a risk radar illustrates the results of the prioritization of risk. For example, as illustrated in FIG. 3B, upon voting (e.g., assigning a numerical assessment to the risk) on the impact of a risk (e.g., significance and likelihood of occurrence) on the key business activity accounting and reporting (associated with the process being reviewed) it was determined that the risk was moderate, or medium, labeled “Yellow” in FIGS. 3A and 3B. This means, that the risk may have an unfavorable impact on the objectives of the process under review and in particular the key business activity associated with the process will be unfavorably impacted as a result of the risks effect on the process. In addition, the need for mitigating action should be assessed, along with the consideration of whether additional resources should be allocated. In these instances, the overall risk exposure is assessed at the level of cautionary. As FIG. 3B illustrates, the assessed risk varies from one business activity or process to another. The risk radar provides a quick interpretation of the risk associated with the process under review, and how the associated key business activities are impacted. In one embodiment, the significance of the risk, and likelihood of the risk occurring may be used to determine the risk radars. For example, a high significance and high likelihood, would lead to a high risk. In one embodiment, a risk radar may be prepared based on an inherent risk and a residual risk. The inherent risk value is an assessment of the risk associated with the key business activity without considering existing activities or processes to minimize or mitigate the risk. The residual risk is the exposure to uncertainty remaining after considering current risk management activities or processes intended to mitigate or minimize the risk. In one embodiment, the inherent risk value and residual risk value are established through the self-assessment performed by the organization, and used to develop the risk radar. The inherent risk value and residual risk value may be compared to determine an assessed risk to the organization. For example, using a scale of 1-10 with 1 being low risk and 10 being high risk: if a risk associated with a key business activity has an inherent risk of 10, and a residual risk of 9, the assessed risk may be high (there is a large inherent risk associated with the key business activity and there is very little done, or done effectively, to mitigate the risk, therefore there is a high risk). If the inherent risk is 10 and the residual risk is 3, the assessed risk may be low (there is a large inherent risk associated with the key business activity, but the organization is effective at managing the risk, therefore the assessed risk is low). The assessed risk may be plotted on a risk radar if desired.

In one embodiment, a desired profile (or tolerance level) of a risk may be established by the participants. Then upon the determination of the risk associated with a key business activity, the risk may be compared with the risk tolerance level. This comparison will help determine if the risk is significant enough, e.g., higher than the tolerance level, to actively pursue mitigation processes.

Upon development of the risk radars, review sessions may be held. The review session may be viewed as the beginning of the process of managing the risks in response to the assessment. The review session may be with the engagement sponsor(s) and may include additional management/personnel. The purpose of the review session is to explain what risks were identified, explain the risk map so the audience may understand the importance of the risk, and discuss the root causes of the risk. Any additional deliverables previously agreed upon may be reviewed, e.g., an executive summary, the key themes, a risk map, and a risk radar. In addition, an action plan for the audience to pursue may be established during the review session, if it hasn't been already. The action plan may include a gap analysis. For example, potential risk mitigation processes that may be utilized to offset the risk, may be discussed, along with plans made to address these mitigation processes. Customer expectations of the risk review, and associated fulfillment of those expectations may be reviewed. The review of customer expectations may be used to determine if there are any issues that were not addressed, or that are misunderstood by the customer. In addition, the risk management team may use the feedback from the review session to further enhance the efficiency of the scoped risk management process.

As mentioned, potential risk mitigation processes may be discussed during the management review session. One form of a risk mitigation process is a continuous improvement process, e.g., continuous quality improvement, business process re-engineering, value based management, total quality improvement (or management), 6 Sigma, Total Quality Initiative (TQI), and AQI etc. That is, if an existing process has an undesirable risk associated with it, then a continuous improvement project (e.g., 6 Sigma project) may be initiated to address the process, and associated risk. Therefore, the management review session may be used to identify and discuss potential continuous improvement projects that may be initiated to help mitigate risk.

In one embodiment, a repository of reviewed processes may be maintained. Portions of the scoping, identification, assessment, and management process may be performed by comparing the process/project currently being reviewed with previously reviewed projects. For example, the process currently being reviewed may be compared with the repository to determine if there have been any similar/analogous process reviewed. If there have been, then the risk identified with the reviewed process may be considered to determine if they are also risk for the current process. In this manner, previous risk reviews may be used to provide guidance on what risk may be applicable to the proposed process, what key processes, sub-process, or inter-related processes may be effected by the risk, what is the significance and likelihood of occurrence of the risk, and what are potential mitigation activities.

In one embodiment, the repository of process reviews may be maintained in a project tracking (or cataloguing) system. For example, a tracking system may contain all of the continuous improvement projects, regardless of the stage of the project. The tracking system may categorize projects by key business activities. For example, a project associated with inventory management may be located under a category of order fulfillment. Cataloguing projects by key business activities may enhance the ability to quickly identify analogous projects and leverage the risk reviews performed for the analogous project. In addition, using key business activities to catalogue continuous improvement projects creates a common, unifying framework for the company. That is, the key business activities have been identified that relate directly to the organization's business objectives and goals. Using these key business activities to catalogue continuous improvement projects helps ensure that proposed projects are directed towards the areas the organization has deemed key for success. Therefore, if resources are limited, the activities may be focused in the areas deemed most important. In one embodiment, the manager of the continuous improvement process may be on an organization's risk management committee (or vice versa) to further ensure the integration of risk management and continuous improvement projects. The repository helps leverage previous risk management efforts thereby further aiding the risk management process.

The management review session may also include discussing and creating a gap analysis. An example of a gap analysis includes assessing the current risk (e.g., significance and likelihood, as illustrated on a risk map). Then the desired risk tolerance may be established (e.g., a desired or acceptable significance and likelihood of occurrence of the risk). A comparison between current risk state and desired risk state may be performed. The comparison may be used to guide risk management efforts. For example, if the difference between the current and desired risk state, as determined by the gap analysis are extreme, then the organization may actively pursue risk mitigation processes. In addition, the comparison between current and desired risk state may provide guidance on whether risk/benefit analysis should be performed. For example, if the organization is comfortable with the difference between the current risk state and desired risk state, then informal risk/benefit analysis may be performed. On the other hand, if the organization is concerned about the comparison, then more rigid or rigorous risk/benefit analysis may be performed in order to determine how to get to the desired risk state. In addition, the gap analysis may be used to determine when more, or less risk should be incurred. For example, if the assessed risks are low, modifying the process to incur some additional risk may be acceptable if the increased risk level results in improved success regarding the defined objectives. The gap analysis may be planned during the engagement and performed by the organization after the engagement.

Upon the completion of these activities the engagement period is concluded, and the risk management process transitions from the assessment phase into the management phase. While the risk management team may still be consulted and participate in meetings, the engagement period itself, and the associated deliverables, have been accomplished at the conclusion of the review session. In one embodiment, due to the scoping process, the engagement period may be completed within a week, from the time of the initial kick-off meeting, to the review session. For example, a kick-off meeting lasting about two hours with all engagement participants could be conducted on a Monday. The meeting would be followed by interviews lasting about one and half hours with each of the participants being interviewed. The interviews and associated analysis may take until Wednesday (depending on the number of participants and/or the number of members on the risk management team). The facilitated review session could occur on Thursday, lasting about four to five hours, followed by the review session on Friday with all the participants to wrap up the engagement period, and lasting about two to three hours. Therefore, the scoping phase leads to a more efficient, focused, and effective engagement period, and is able to condense into a week, what other engagement periods draw out to several months or more.

Managing the risk in response to the assessment may include the implementation of one or more action plans to mitigate the risk. In addition a gap analysis may be performed (if it hasn't been) between current process capabilities, desired process capabilities, and risk, regarding the process being reviewed. Additional management techniques may include monitoring the operating environment to identify potential changes in the process, the mitigation process (if used), the risk profile, including monitoring the success (or failure) of the risk management strategy, the impact of change events (both internal and external) on the process, and the variability of meeting performance targets (and what caused the variability). Action plans may be developed when required due to change in risk profiles. In general, the process, associated key business activities, risks, and mitigation processes may be monitored and acted upon to implement a continuous improvement process associated with the organization.

Results of the scoped risk management process may be passed to other portions of the organization. For example, a company may have multiple tiers. An upper tier may include an Executive Office. Lower tiers may include a finance department, an accounting department, an inventory management department, etc. Results of risk management activities may be passed upward (or rolled up) to the next higher tier (if there are multiple tiers), or straight to the upper tier. In one embodiment, the rolled up results may be correlated with each other and/or with an identified upper tier process. For example, the finance department may perform risk management for one of their processes. The process may be correlated with one or more key business activities. The key business activities identified by the upper tier (or the finance department) may be analyzed with respect to identified risks (risk types). As described earlier, the results could be visually illustrated in a risk radar that could be passed upward, along with other information. The upper tier may then review the key processes of the company (e.g., processes from the finance department) with respect to the key business activities and/or risk types. In one embodiment, a plurality of risk maps or risk radars associated with a common key business activity may be correlated with each other to establish a combined risk map or risk radar. The combined risk radar may highlight which key business activities are of the highest risk. A combined risk map may also highlight which risk types are consistently causing concern. In this manner, the upper tier may attempt to manage the risk from a high level. For example, they may decide to spend additional resources (time, money, training etc.) in particular areas at the corporate level to help mitigate the risk. In one embodiment, the risk mitigation processes may also be reviewed to determine if there are any consistent processes, or best practices, that may be implemented across the lower tier to help mitigate the apparent common risk. For example, if there is a recurring risk type associated with accounting and reporting, the upper tier may decide to provide a training program to mitigate the risk.

In one embodiment, the risk types and key business activities used during the risk management process are established in the lower tiers. Therefore, when the upper tier receives the results from the lower tiers, the results may be correlated to establish common key business activities, risk types, and/or risk mitigation techniques, if there are any. Alternatively, the risk types and/or key business activities may be established by the upper tier, and passed down to the lower tier. In this manner, the upper and lower tiers are characterizing processes (and associated key business activities and risk) in common terms, thereby enabling easier correlation from multiple lower tier departments.

In one embodiment, a summary assurance, direct assurance, and/or a process assurance may be established at a lower tier through the risk management process, and passed to an upper tier. As will be described, providing these assurances enables the upper tier to understand whether risks are being managed appropriately, what the risks are in particular areas, and what the common risks are. In this manner, the upper tier may actively manage the risk at their level also, e.g., provide funding for training, update computing systems, address employee turnover etc.

A summary assurance is a corporate view of business risk management (e.g., a summary of the department, process, and/or functional risk associated with the organization). The summary assurance may be provided by the risk management team, and may include a composite organizational risk assessment (e.g., risk maps and/or risk radars) based on consolidation and analysis of multiple risk management reviews (e.g., consolidating multiple risk maps, risk radars etc.), based on the activities of the engagement periods with respect to multiple groups. In addition, the summary assurance may include results associated with facilitating self-assessments, initiating departmental training on risk management (e.g., how to perform risk reviews, how to identify, assess and manage risk, how to utilize corporate tools for risk management, etc.), facilitating the usage of a common language throughout the company for risk management/continuous improvement, and facilitating a repository (or knowledge base) through which information associated with risk management activities may be maintained. In addition, the summary assurance may include results (or portions thereof) of the particular facilitated self-assessments such a risk map and/or risk radar, etc. The summary assurance may include results, or planned actions, associated with the ongoing risk management processes, e.g., plans/results of mitigation processes, training performed, identification of processes, tools and techniques used during the self-assessment. The integration of the risk management activities with other organization tools/functions such as a knowledge management system may also be provided.

A direct assurance may be provided by a particular organization (e.g., the self assessor) that has reviewed one or more processes. The direct assurance is a review of the risk associated with a specific department, project, process and/or function within a department. The direct assurance includes the utilization of a variety of techniques to gather sufficient evidence to assure that risk management activities are adequate to achieve desired objectives. In particular, direct assurance includes the engagement sponsor (or process owner) taking the results of scoped risk management reviews and other self-assessments, and delivering the results to the upper tier.

A process assurance includes a review of the processes used to perform risk management within the organization. The upper tier may utilize the results of the process assurance to understand how accurate the results of the direct assurance are. The process assurances may be performed by an audit team (or department). The method of providing assurance includes auditing the risk management process used to review at least one process. The results of the audit may be reviewed by the engagement sponsor and/or passed up to an upper tier in the organization for review. The audit may determine the quality/robustness of the risk management process embedded within the organization, and recommend changes to the risk management processes utilized.

In one embodiment, a risk based audit model may be utilized by the audit team to assess the organization's risk management process and/or to prioritize the reviewed processes for audits. One embodiment of a risk audit model associated with a reviewed process includes utilizing information previously established, e.g., an identified risk associated with a key business activity. An inherent risk value and a residual risk value may be assigned to the risk, if they haven't been already during the self-assessment.

Once the risk is assessed (either through self-assessment, or with the assistance of another group), the assessment process may be reviewed or audited. For example, the risk management processes relied on to mitigate the risk (and thereby establish the residual risk value) may be assessed by an audit group with respect to capability maturity, and may have a maturity value assigned to them. The maturity value may range from 1 to 10, 1 being high maturity and 10 being low maturity.

There are several ways in which the capability maturity of a risk management process may be assessed. In one embodiment, a maturity value may be established based on the maturity of the process. Process maturity may range from the process being an ad hoc/chaotic process (e.g., lacking institutional capability), an intuitive process (a process has been established and is repeatable), a qualitative/quantitative process (policies, process, and standards are defined and institutionalized), a quantitative process (risks measured/managed quantitatively and aggregated organization wide), to an optimum process (where risk management is a source of competitive advantage). A maturity value may be established based on the category that best describes the process. The inherent risk value, residual risk value and maturity value may be compared to establish an audit risk value.

In one embodiment, the audit risk value may be determined by determining the difference between the inherent risk value and the residual risk value, and then multiplying the result by the maturity value. For example, for an inherent risk value of 10, residual risk value of 9, and maturity value of 3, the audit risk value would be (10−9)*3=3. Using these value ranges, the audit risk value may range from 0−90, with 0 being a low audit value meaning there is less need to audit the process and 90 being a high audit value meaning there is a high need to audit the process. In another example, for an inherent risk value of 10, residual risk value of 3, and maturity value of 7, the resulting audit risk value is 49 ((10−3)*7=49), indicating that the process associated with that risk should be given a higher priority for auditing than the process in the prior example (audit risk value of 3). In general, if a process has a high inherent risk value, and a high residual risk value, the assessed risk is high and the organization is aware of the high risk and will be prompted to actively manage the risk associated with the process. If a process has a high inherent risk value and a low residual risk value, meaning the assessed risk value is low, as self-assessed by the organization, this is a preliminary indication of a well managed risk. However, if a maturity assessment (e.g., performed by the auditing group) indicates the risk management processes used to achieve the low residual value are of low maturity, there is an increased potential that the organization's self-assessment of residual risk is inappropriate or misleading. The conclusion may be reached that the organization is placing undue reliance on risk management processes that are immature or inappropriately assessing the risk. Such a situation may be given a higher audit priority by the auditing group in order to substantiate the robustness of the organization's risk management processes and thereby substantiate the organization's self-assessed residual risk value. Therefore the audit prioritization process helps to identify potential areas which warrant closer scrutiny and prioritizes the processes for purposes of auditing. Once multiple processes are assessed, and associated audit risk values established, the audit risk values may be ranked (e.g., highest to lowest) and used by an auditing group to determine which processes to review first, or most frequently.

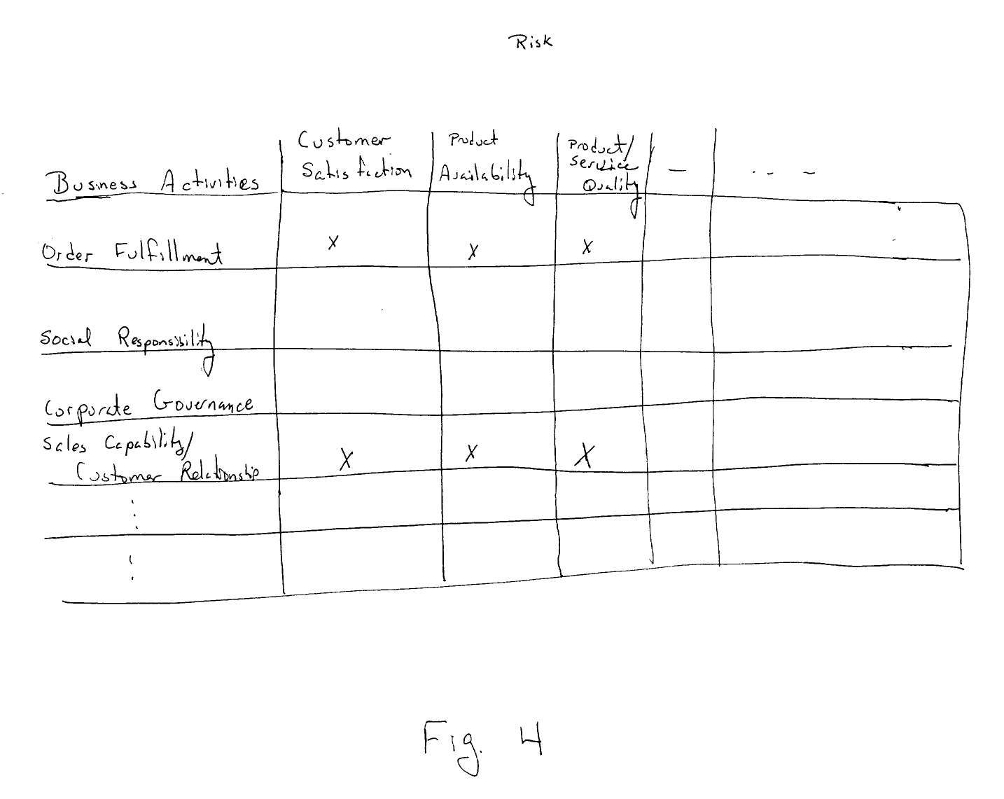

In one embodiment, a risk matrix may be developed at an upper tier and passed down to lower tiers for use during self-assessments or audits. For example, the upper tier may establish the key business activities associated with the upper tier, which in one embodiment would inherently include the key business activities of the lower tiers. The upper tier may then identify a plurality of business risk or risk types that may affect one or more of the key business activities. The upper tier may also establish which key business activities may be impacted by the risk, e.g., through a risk matrix, as illustrated in FIG. 4. The risk matrix may provide a baseline of which risk may apply to which key business activities. Therefore, when the lower tier is performing a self-assessment, they may quickly identify which processes should be reviewed in their particular area, to correlate the process with the key business activities. The key business activities may then be associated with the baseline risk types (e.g., via the risk matrix). Therefore, the organization may quickly have a baseline set of identified risk, which they may use to tailor to their particular environment. In one embodiment, the flowing down of key business activities and associated risk, e.g., via a risk matrix, further facilitates the scoped risk management process. For example, the time spent by the reviewing organization to establish which process to review, and identifying the associated key business activity and risk, may be reduced by utilizing the risk matrix, further reducing the time needed to perform the scoped risk management process.

In one embodiment, the scoped risk management process may be integrated with other business functions. Risk management may provide a common framework with which groups (e.g., departments etc.) within the organization communicate and work together. For example, the scoped risk management process may be used as a framework for continuous improvement processes, and/or an organization's knowledge database. For example, an organization may have a continuous improvement process (e.g., 6 Sigma, AQI, TQM etc.) that fosters the identification and engagement of projects throughout the organization that are aimed at improving the processes of the company. The continuous improvement process may use an aspect of risk management (e.g., the established key business activities) to categorize all projects being performed. By categorizing continuous improvement projects in terms of the key business activities, the organization may help ensure that improvement activities are being directed towards the business activities most important to the organization, and the risk associated with the business activities. In addition, by using the frame work associated with the common language (e.g., key business activities) for the knowledge base, information being discussed/collected relative to the key business activities of the organization may be easily identified and utilized.

Industrial Applicability

The present disclosure is associated with a method of managing risk associated with a process. The method includes the steps of, establishing a scoped risk management process in response to the established process, identifying at least one risk associated with the process in response to the scoped risk management process, and assessing an impact of at least one risk identified impacting the process.

In one example, a group responsible for inventory management may decide to do a risk self-assessment, and therefore contact a risk management team/coordinator to facilitate. The coordinator may be someone internal to the inventory management group who is fulfilling the role of a facilitor/coordinator. The inventory management group could do a self-assessment without the risk management team/coordinator, if desired (e.g., through the use of a survey or other information collection tool/technique). The group may know what process or sub-processes they desire to review. Alternatively the risk management team may help establish what process or sub-processes to review in scoping the engagement. A scoping meeting is held with the engagement sponsor and risk management team or coordinator. The scoping meeting is part of a scoping process performed to prepare for an engagement period. The engagement sponsor may indicate that the group is expanding its product line resulting in the expansion of the facility and inventory levels. At the same time the organization is implementing a new purchasing system. Inventory management may be correlated to the key business activities of the organization (e.g., to determine which key business activities are most affected by the process). Examples of key business activities for the company may include: social responsibility, corporate governance, strategic business planning, product/service development, sales capability/customer relationship management, order fulfillment, product and service support, information management, financial products, human resources, treasury, and accounting and reporting. In this example, the process to be reviewed may be as broad as order fulfillment. Alternatively the process to be reviewed may be narrowed to the purchasing process, or capacity planning/process. In one embodiment, the inventory management process (or purchasing process or capacity planning process) may be correlated to the key business activities of order fulfillment, sales capability/customer relationship management, accounting and reporting, product/service development, and social responsibility. A decision may be made as to whether to include all of the correlated key business activities in this particular engagement's scope, or whether to limit the scope to just one key business activity, e.g., order fulfillment. For example, the risks that may specifically impact order fulfillment may be identified and assessed, as opposed to the identification and assessment of the risk associated with all of the key business activities. This decision may be made by the engagement sponsor. Focusing the engagement's scope to order fulfillment enables a more detailed review of the order fulfillment process to be performed, and appropriate attention may later be spent on another key business activity such as social responsibility. Alternatively, the engagement sponsor may decide that the key business activities are tightly linked with respect to the facility expansion and the purchasing system and therefore may desire to assess the business activities simultaneously. As mentioned, the decision to scope the self-assessment to one or more particular business activities is implementation dependent, and may be made on a case by case basis. For this example assume the engagement sponsor desires only to address order fulfillment at this time.

Once the process to be reviewed is identified, a risk time period may be established. In this particular example, the facility expansion is to occur in ten months, and the purchasing system is to be installed in six months, and then stabilized for six months. Therefore, the risk time period may be twelve months, the time anticipated for installation and stabilization of the purchasing system, which is anticipated to be longer than the ten months to expand the facility. In one embodiment, the capability maturity of the risk management process may be taken into account to aid in determining the risk time period. As mentioned, the capability maturity may range from “initial” (e.g., ad hoc or chaotic) to “optimizing” (risk management a source of competitive advantage). If the process is considered “initial” then the risk time period may focus on the near term. That is, the group needs to focus on meeting its near term objectives, and less on long term objectives which are arguably less important due to the risk of not fulfilling the near term objectives. On the other hand, if the process is very mature (i.e. “optimizing”) then the risk time period may be extended to look at risk further out in time. In this particular example, the risk management processes of the inventory management group may be deemed to be at an “initial” capability maturity stage, thus prompting a near term focus for the engagement's scope. Since there are significant changes to the existing environment occurring in the near term (facility expansion and new purchasing system) and the capability maturity of the risk management processes may be considered low, the near term risk is high, therefore the risk time period should be near term as opposed to long term. Other information that may be discussed during the scoping meeting includes, any recent organizational changes, any anticipated (or actual) trends, any strategy updates, and any information that may be used to prepare for the upcoming engagement.

The interview process may be tailored based on the information obtained during the scoping meeting. For example, baseline questions associated with key business activities that aren't associated with, or impacted by the process being reviewed, may be eliminated. Follow-up questions may be established. Examples of baseline questions may include asking an interviewee to describe their area of responsibility and upcoming issues they foresee. If they work in the purchasing group, and do not mention the new purchasing system, then the interviewer may follow-up with why the person does not perceive the new system to be a concern. Questions regarding upcoming challenges with respect to achieving the organization's critical success factors may be posed. These questions may address challenges related to profitability, innovation, market trends, cost (internal and external), and team related issues. Questions regarding upcoming challenges may be tailored to identify additional challenges within the next twelve months (the risk time period). The tailored questions may be used to ensure that certain key points of discussion are drawn out during the interviews. The baseline questions may determine long term business goals, future trends, organizational changes, issues that could prevent the achievement of business goals, etc.

Risk identification is then performed. A kick off meeting may be held followed by individual interviews. Potential or actual risks may be identified during the interviews. These risks may be associated with known changes or trends. For example, the interviewees may indicate that there is an increase in the requirements of the organization's customers (i.e., failure to satisfy customers is a risk, and not knowing customer requirements, or changes therein, is a risk). Customers are more demanding, won't accept poor quality, and won't tolerate missed delivery dates. In addition, the interviewees may indicate that resource allocation and knowledge capital are issues. There may be a high turnover rate in the software group implementing the new purchasing system, thereby increasing the risk of time delays, and system quality.

The comments obtained during the interviews may be categorized by risk type. For example, all comments associated with the risk type customer requirements may be placed under that heading. In this manner, the most prevalent risks, based on the number of comments, may be identified. If a large number of risks are identified during the interview process, the number of times the risk is cited, the number of comments associated with each risk, and/or the distribution of comments may be used to help prioritize the risk, or create key themes. This risk prioritization may be used to help reduce the number of risks reviewed and voted upon during the assessment phase. The categorization of comments by risk type may take place during or just after the interviews.

In one embodiment, risk assessment (or even the prior identification of risk) may include determining the significance of the risk if it occurs (what will be the impact on achievement of business objectives), and the likelihood that the risk will occur. For example: what is the impact on achievement of business objectives if quality is poor, and what is the likelihood that the organization will have poor quality. In this example, poor quality may be associated with the wrong parts being ordered by the new purchasing system. Poor quality may also result from the facility expansion if the expansion proceeds at such a hectic pace that adequate training is not provided to employees.

In another example: what is the impact on achievement of business objectives if customer satisfaction declines and what is the likelihood that we will have a decline in customer satisfaction. In this example, if new storage equipment is being incorporated in the new portion of the expanded facility, the new storage equipment may not be able to support inventory management effectively, leading to missed ship/delivery dates, and parts shortages directly effecting the end customer. In addition, expanded facilities may lead to inventory placement/packing inefficiencies, causing additional delays in delivery of products to the end customer.

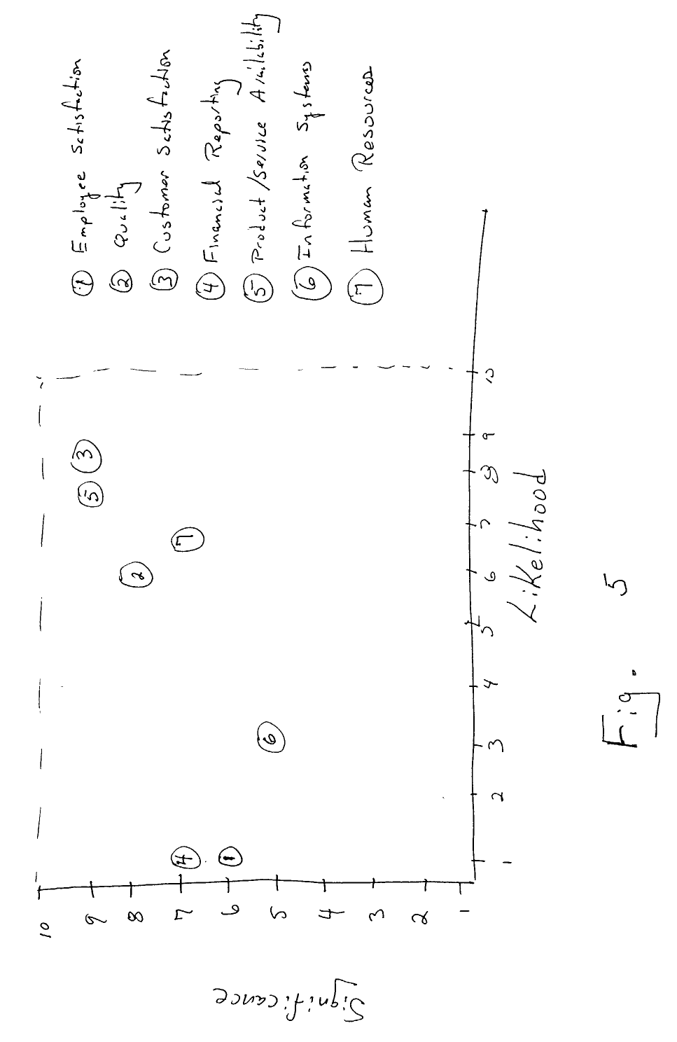

The likelihood/significance of a particular risk may be assessed, e.g., determined through a voting process among the participants, and plotted on a risk map, such as the one illustrated in FIG. 5. The risk map provides a visual of the significance and likelihood of the risk, and is based upon the discussions the group had during the self-assessment of these risks. Using the risk map, or underlying information, the group may determine which risk(s) to address further. In general, a risk may be either accepted or managed. Risk of lower significance or lower likelihood of occurring may be accepted. The group may vote on which risk, e.g., customer satisfaction, poor quality, etc. to manage.

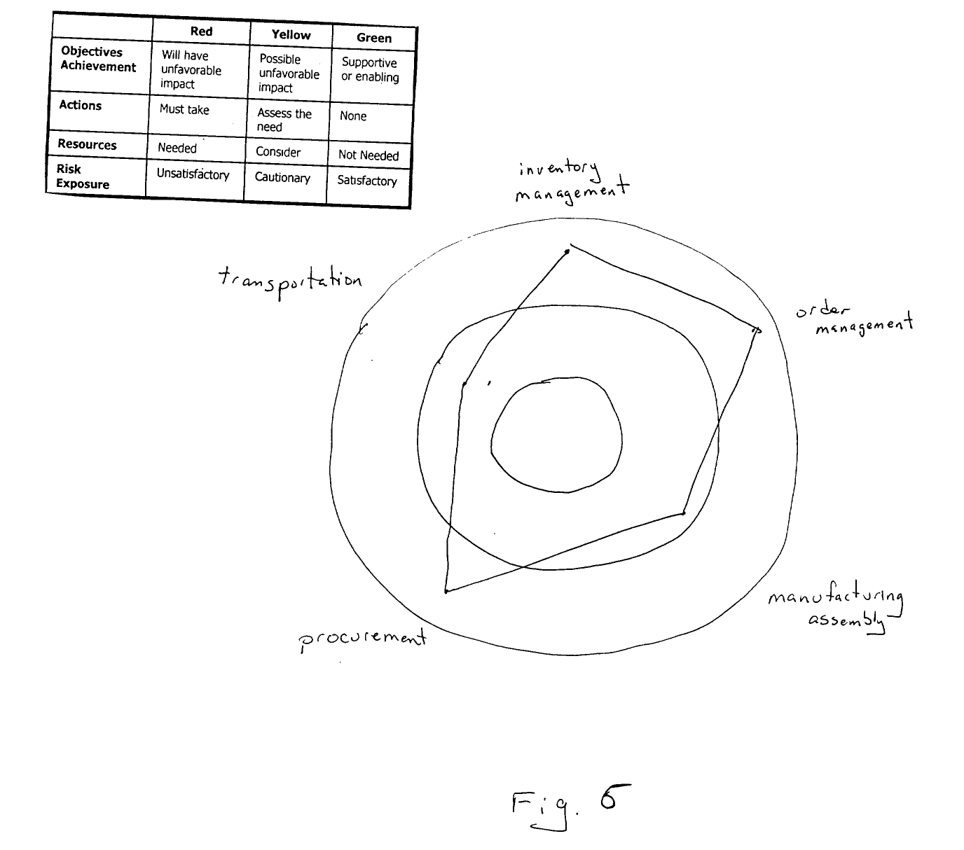

A risk radar may be created after the risk map has been created. The risk radar may be created in several ways. If there are multiple key business activities that have been reviewed during the engagement period, the risk radar may include a visual indication of the overall risk associated with these key business activities, as illustrated in FIG. 3B. If, as in this example, only one key business activity (order fulfillment) is focused on during the engagement period, then the risk radar may include sub-processes associated with the key business activity. That is, the risk radar may provide a visual indication of the risk associated with the processes supporting the key business activity. In this example, the supporting processes of order fulfillment may include inventory management, order management, manufacturing and assembly, procurement, and transportation, as illustrated in FIG. 6.

In one embodiment, if additional assessments are needed regarding a supporting process which is located in another area of the company, i.e. managed by a different process owner, then the different process owner may be requested by the engagement sponsor to perform a risk assessment of that process and share the results.

During the engagement period, discussions may occur regarding how to manage the identified risk. For example, once the risks have been identified and prioritized, the group may select which risks to address. Potential risk mitigation processes may be discussed. For example, one risk with the new purchasing system is that it may not function properly, or it may have initial inefficiencies. Therefore, the potential mitigation processes may include, testing the system with previous purchasing data to verify the accuracy/reliability of the system, prior to letting the system go live. In addition, once the system is up and running, the previous purchasing system may continue to function in the background in parallel to ensure that if there are any discrepancies, the new system can be corrected. In addition, mock transactions may be generated in order to exercise the newly expanded facility before the facility is deemed fully functional. This may enable people to become familiar with the layout of the facility and the efficiency of the bin locations etc. Therefore, potential risk mitigation processes may be identified and assessed to determine which ones to pursue. The discussions may include a risk/benefit analysis to determine if the benefits of performing the risk mitigation process outweigh the cost of performing the process, and/or the risk of not performing the risk mitigation process.

The information obtained during the risk management self-assessments may be used to provide a summary assurance and/or direct assurance to an upper tier of the organization. For example, inventory management impacts the key business activity of order fulfillment. A company wide assessment of order fulfillment may be performed. The company has multiple departments. This assessment may include correlating existing risk management activities, and/or assessing order fulfillment in areas where it has not been assessed. The company wide assessment may include correlating information such as that contained in each department's risk radar focused on order fulfillment and its supporting processes. That is, a company wide risk radar, encompassing multiple departments, may be prepared with respect to order fulfillment. The risk radar may include multiple key business activities, as illustrated in FIG. 3B, or may include multiple supporting processes, as illustrated in FIG. 6. In one embodiment, the overall significance of the risk may be established based upon the financial impact associated with the process, how often the process is referenced in the individual assessments, or based upon the risk maps established based on significance and likelihood of risk. In one embodiment, the risk management results are reviewed and combined into a consolidated result. Consolidation of results enables the reviewer the ability to assess the significance of the risk towards the business activity (e.g., order fulfillment) across the organization. The information may be utilized to determine the key processes associated with order fulfillment, the risk status of the supporting processes, and the type of mitigation processes that may be implemented. Types of mitigation processes that may be implemented include increased training, upgrading computing systems, etc.

A mechanized system may be utilized that will consolidate the risk management results (e.g., risk maps or risk radars) in an automated manner. The inputs to the computing system may include information associated with the individual risk management reviews, e.g., risk radars, risk maps, inherent/residual/maturity values, and/or financial impact etc.

As mentioned, the scoped risk management process may be integrated with other business functions. For example, once the risks associated with a process are identified, either at a top tier or lower tiers, a particular process owner may be responsible for monitoring the risk. For example, an organization's business information group may monitor any external risk, or identify and monitor external indicators that contribute to the risk. Therefore, the business information group is able to monitor external issues associated with external risk and provide early indications of changes in the risk profile when the external risks change and develop risk mitigation strategies as needed.

The risk management activities may be a factor used to guide an organization's process to evaluate potential mergers and acquisitions. For example, in one embodiment, a review of the processes used to assess the value of a merger or acquisition may be performed in order to assess risk associated with the process, thereby enabling process improvement to be identified. That is, through the assessment of the merger and acquisition process, an inherent risk value, a residual risk value, and a maturity value may be established. Through the use of these values, a determination may be made regarding the risk associated with the assessment of a merger or acquisition. For example, there may be a assessment of a merger indicating that there is a low risk. However, the robustness of the mergers group's risk management process, as assessed by the auditing group's “process” assurance, will provide insight into the quality of the merger group's assessment.

In addition, risk management may be used to identify external factors that contribute significant risk to the organization, or a key process within the organization. This information may be used to determine whether a merger or acquisition may be performed to mitigate the risk. For example, if one large external risk, as determined through a self-assessment of a manufacturing group, is the supply of a particular part or resource from an external source, then the merger and acquisitions group may use the information to assess a possible acquisition of a supplier of the part or resource in order to mitigate the risk posed to the manufacturing group.

Other aspects, objects, and advantages of the present invention can be obtained from a study of the drawings, the disclosure, and the claims.

What is claimed is:

1. A method of managing risk associated with a process, including the steps of:
establishing a scoped risk management process in response to said process;
identifying at least one risk associated with said process in response to said scoped risk management process; and
assessing an impact of said at least one identified risk on said process.

2. A method, as set forth in claim 1, further comprising the step of managing said at least one identified risk in response to said assessment.

3. A method, as set forth in claim 1, further comprising the step of establishing a plurality of business activities.

4. A method, as set forth in claim 1, wherein the step of establishing said scoped risk management process includes the steps of:
establishing a plurality of objectives associated with said risk management process;
establishing said scoped risk management process in response to said one or more objectives.

5. A method, as set forth in claim 4, wherein the step of establishing said plurality of objectives includes the steps of:
establishing said plurality of business objectives with at least one of an engagement sponsor and a project owner.

6. A method, as set forth in claim 3, wherein the step of establishing said scoped said risk management process includes the steps of:
selecting a subset of said plurality of business activities in response to said process.

7. A method, as set forth in claim 6, wherein the step of establishing said scoped risk management process in response to said selected activity subset further comprises the step of:
tailoring an interview process to said selected activity subset.

8. A method, as set forth in claim 3, wherein the step of establishing said scoped said risk management process includes the steps of:
establishing a time period of said risk.

9. A method, as set forth in claim 1, wherein the step of establishing said scoped risk management process further includes the steps of:
establishing a plurality of business activities;
establishing a subset of said activities in response to said process;
establishing a risk time period in response to said process;
tailoring an interview process to said process in response to said established risk time period and said established activity subset.

10. A method, as set forth in claim 1, wherein said step of identifying at least one risk, further comprises the steps of:
interviewing at least a portion of said project team and responsively obtaining interview results;
compiling said interview results anonymously;
identifying said at least one risk based on said compiled interview results.

11. A method, as set forth in claim 10, wherein said step of accessing said risk impact includes the step of self-assessing said risk impact.

12. A method, as set forth in claim 1, wherein said the step of identifying said risk is performed at a lower tier of a multi-tier organization.

13. A method, as set forth in claim 12, wherein the step of assessing said risk impact is performed at said lower tier.

14. A method, as set forth in claim 13, wherein the step of managing said assessment includes delivering a result of said risk impact assessment to an upper tier of said multi-tier organization.

15. A method, as set forth in claim 14, wherein said multi-tier organization includes a plurality of lower tiers associated with said upper tiers, further comprising the step of delivering a plurality of said risk impact assessment results associated with said plurality of said lower tiers, to said upper tier.

16. A method, as set forth in claim 15, further comprising the step of correlating said plurality of low tier risk assessment results into a risk assessment result associated with said upper tier.

17. A method, as set forth in claim 15, wherein the step of correlating said plurality of lower tier risk assessment results further includes the steps of:
establishing a process associated with said upper tier;
identifying at least one risk associated with said upper tier process; and
assessing an impact of said upper tier process risk and said plurality of said risk impact assessments associated with said plurality of said lower tiers, on said process.

18. A method, as set forth in claim 15, wherein said risk impact assessment results are illustrated in a graphical representation.

19. A method, as set forth in claim 18, further comprising the step of correlating said plurality of lower tier illustrated risk assessment results into a risk assessment result associated with said upper tier, said risk assessment result being illustrated in a graphical representation

20. A method, as set forth in claim 1, further comprising the step of auditing a risk management process, said risk management process being associated with said risk identification and said risk impact assessment.

21. A method, as set forth in claim 20, said the step of auditing said risk management process is performed at a lower tier of a multi-tier organization.

22. A method, as set forth in claim 21, further comprising the step of delivering said risk management process audit to an upper tier of said multi-tier organization.

23. A method, as set forth in claim 22, further comprising the step of providing a process assurance to said upper-tier in response to said risk management process audit.

24. A method, as set forth in claim 22, wherein the step of providing said process assurance further comprises the steps of:
establishing a quality of a risk management process associated with said process,
establishing a quality of a risk management method associated with said process;
establishing a degree of incorporation of metrics associated with said process;
establishing a quality of reporting associated with said process.

25. A method of managing risk associated with a process, comprising the steps of:
identifying at least one risk associated with said process;
establishing an inherent risk value associated with said identified risk;
establishing a residual risk value associated with said identified risk; and
assessing said process in response to said inherent risk value and said residual risk value.

26. A method, as set forth in claim 25, further comprising the step of:
establishing a maturity value associated with said assessment.

27. A method, as set forth in claim 26, further comprising the step of auditing said risk assessment process in response to said risk assessment maturity value.

28. A method of managing risk associated with a process, comprising the steps of:
identifying at least one risk associated with said process;
establishing an maturity value associated with at least one of said process and a risk mitigation process; and
assessing said process in response to said maturity value and said identified risk.

29. A method, as set forth in claim 28, further comprising the step of auditing said process in response to said maturity value.

30. A method of managing risk associated with a process, the process being associated with a multi-tiered organization, comprising the steps of:
establishing said process to be managed at a lower-tier of said multi-tiered organization;
identifying at least one risk associated with said process, said identification occurring at said lower-tier;
assessing an impact of said risk, said assessment occurring at said lower-tier;
delivering a direct assurance to an upper tier of said multi-tiered organization.

31. A method, as set forth in claim 30, further comprising the step of delivering at least one of a summary assurance and a process assurance to said upper tier.
